(19) United States
(12) Patent Application Publication
(10) Pub. No.: US 2022/0102703 A1
(43) Pub. Date: Mar. 31, 2022

(54) PRODUCTION METHOD FOR CONDUCTIVE POLYMER INORGANIC SOLID ELECTROLYTE SECONDARY BATTERY

(71) Applicant: PIOTREK CO.,LTD., Kyoto (JP)

(72) Inventor: Tsutomu SADA, Kyoto (JP)

(73) Assignee: PIOTREK CO., LTD., Kyoto (JP)

(21) Appl. No.: 17/426,346

(22) PCT Filed: Jan. 27, 2020
(86) PCT No.: PCT/JP2020/004442

§ 371 Date: Jul. 28, 2021

(30) Foreign Application Priority Data
Jan. 29, 2019 (JP) 2019-26925

(51) Int. Cl. H01M 4/139; H01M 10/0562; H01M 10/0585; H01M 4/04

(52) U.S. Cl. CPC H01M 4/139; H01M 10/0562; H01M 2004/028; H01M 4/0435; H01M 4/0471; H01M 10/0585

(57) ABSTRACT

Production of conductive polymer inorganic solid electrolyte secondary batteries: (I) producing positive electrode with close-packed structure having a pore packing rate of at least 70% including a conductive material and an ion-transfer binder; (II) positive electrode obtained in (I) impregnated and filled and/or surface thin-film coated with conductive polymer solution; (III) inorganic solid electrolyte blended into the conductive polymer solution and casting shiny prepared on the positive electrode obtained in (II), surface-coated, and integrally formed with the positive electrode, or conductive polymer solid electrolyte membrane is prepared, press-bonded, and molded into two layers, to produce a positive electrode; heating (IV) positive electrode having the conductive polymer and inorganic solid electrolyte obtained in (III); and (V) positive electrode having conductive polymer solid electrolyte obtained in (IV) and bonding/heat pressing a negative electrode, or a negative electrode having the conductive polymer formulation solution impregnated and filled and/or surface thin-film coated thereupon.

### FIELD OF THE INVENTION

According to this invention, an integral molded rechargeable battery containing a conductive polymer and an inorganic solid state electrolyte can be produced under an extremely competitive cost.

Further, restraining to the fullest the interface resistance of the particles and/or the internal resistance of solid state electrolyte membrane layer with the closed pack structure of positive and negative electrodes in forming a hetero-bonding with the active materials' particles of the both electrodes by the conductive polymer filler formulated inorganic solid state electrolyte into voids of the closed pack structure electrodes in the rechargeable battery cell, and also forming ion conductive polymer matrix to enhance Li+ ion transfer for rendering the inherent bulk conductivity of the inorganic solid state electrolyte to the fullest.

And also, this manufacturing method is to obtain characteristics feasible a cell formation obtaining a thinner cell thickness and a flexible cell structure.

Beside, by this invention the battery having less dependence on operational temperature and in accidental short circuit the safety maintained excellently with the conductive polymer toward an inorganic solid state electrolyte type rechargeable battery nevertheless without a separator part

### BACKGROUND ART

Japanese Patent Kokai No. 2002-313424 (Patent reference 1) proposes a rechargeable battery using an inorganic solid state electrolyte membrane comprising a conductive polyether polymer and a ceramic whisker. However, thus obtained battery has much grain boundary resistance and by occurring much boundary resistance of the inorganic solid state electrolyte the battery has not sufficient conductivity property and much dependence on the temperature, and also it has a lack of low temperature property since it has an usage restriction because of performing as the most excellent property at higher than 60° C.

Further, Japanese Patent Kokai No. 2014-238925 (Patent reference 2) proposes a solid electrolyte comprising a Garnet type of inorganic solid state electrolyte layer and a polyether polymer conductive polyether layer. However, by being influenced to the conductivity restriction of polyether polymer having a high softening point, this method has some disadvantage such as the intrinsic conductivity of Garnet solid state electrolyte and NASICON type crystal structure is made downward drastically.

Further, PCT-WO2013/073038 (Patent reference 3) proposes a process for sintering a rare earth metal as niobium to the positive electrode or heat bonding solid electrolyte coated to the particles, as the method of improving the interface resistance of the articles, in case of using the inorganic solid state electrolyte such as phosphorus lithium sulfide (LPS)

Various composite polymeric conductive composition having an excellent conductive property have been popularly known. For example, the above Patent reference 1 and Patent reference 2 propose a composite polymeric conductive composition with the molten salt polymer having a quaternary ammonium salt structure comprising quaternary ammonium cation group and anion group containing halogen atom, and also containing a polymerizable functional group. PCT-WO2018/043760 (Patent reference 4) proposes lithium ion battery comprising the above composite polymeric conductive composition and ceramic inorganic solid state electrolyte. However these Patent references do not disclose the complete process for preparing the inorganic solid state electrolyte lithium ion battery having high performance efficiently

### PRIOR ARTS

Patent reference 1: Japanese Patent Kokai No. 2002-313424
Patent reference 2: Japanese Patent Kokai No. 2014-238925
Patent reference 3: PCT-WO2013/073038

### SUMMARY OF THE INVENTION

### Subjects to be Solved by the Invention

The purpose of this invention is to obtain a manufacturing process for solid state electrolyte type rechargeable battery formed in a process of superposing the opposite side electrode with the electrode combining the inorganic solid state electrolyte layer in an integral molding or two layer molding methods under an extremely competitive cost. Further, to obtain a manufacturing process for a high performance of macromolecule conductive polymer solid state electrolyte type rechargeable battery, in particular lithium ion battery (LIB), in which active material's particles of both electrodes an interface resistance among those particles and also with the conductive polymer inorganic solid state electrolyte layer can be restrained to the fullest. Furthermore in particular, in case of utilizing lithium metal foil as an anode part to obtain a manufacturing process for conductive polymer solid state electrolyte rechargeable battery enhancing a safety issue on reduction resistance by film-forming a higher capacity of polymeric conductive polymer as anti-reduction buffer layer on surface of lithium metal foil under a heat cross linking or photo polymerization methods.

### Means to Settle Down the Subjects

The purpose of this invention is to achieve by providing a manufacturing process for a rechargeable battery making a coating layer with the casting slurry comprising a conductive polymer and an inorganic solid state electrolyte or placing a membrane comprising a conductive polymer and an inorganic solid state electrolyte between positive and negative electrodes, which comprises the First step—I of preparing a positive electrode comprising an active material, a conductive agent and an ion conductive binder, and herein having at least 70% of the closed pack structure and the Second step—II of impregnating in filling or surface coating in a thin layer with a conductive polymer solution toward the positive electrode obtained by the First step—I, the Third step—III of preparing the positive electrode made in an integral formation by coating a casting slurry containing the conductive polymer solution and the inorganic solid state electrolyte on those surfaces or by pressing the membrane comprising the conductive polymer and the inorganic solid state electrolyte in two layers formation on the positive electrode, obtained by the Second step—II, the Fourth step—IV processing by heating the positive electrode obtained by the Third step—III at 60 to 100° C. for 5 to 60 minutes, and the Fifth step—V processing by heat-pressing in overlaying the positive electrode obtained by the Fourth step—IV with the negative electrode. The formulation of this positive electrode is applicable to that of the negative electrode.

The purpose of this invention is to achieve more preferably by providing a process for producing a rechargeable battery making a coating layer with the casting slurry comprising a conductive polymer and an inorganic solid state electrolyte, or placing a membrane comprising a conductive polymer and an inorganic solid state electrolyte between positive and negative electrodes, which comprises the First step—I of preparing a negative electrode comprising an active material, a conductive agent and an ion conductive binder and herein having at least 70% of the closed pack structure having and the Second step—II of impregnating in filling or surface coating in a thin layer with a conductive polymer solution toward the negative electrode obtained by the First step—I, the Third step—III of preparing the negative electrode made in an integral formation by coating a casting slurry containing the conductive polymer solution and the inorganic solid state electrolyte on those surfaces or by pressing the membrane comprising the conductive polymer and the inorganic solid state electrolyte in two layers formation on the negative electrode, obtained by the Second step—II, the Fourth step—IV processing by heating the negative electrode obtained by the Third step—III, at 60 to 100° C. for 5 to 60 minutes, and the Fifth step—V processing by heat-pressing in overlaying the negative electrode obtained by the Fourth step—IV with the positive electrode

The purpose of this invention is to achieve more preferably by providing a manufacturing process of a rechargeable battery, wherein the negative lithium metal electrode forming a polyether type polymer interlayer as a dendrite generation buffer on the one side surface or the both side surface of a lithium metal foil is used as the negative electrode in the above mentioned invention

The purpose of this invention is to achieve more preferably by providing a manufacturing process of a rechargeable battery, wherein an ionic liquid and an charge transfer ion sources are contained into the conductive polymer solution in the Second step—II and/or the casting slurry containing the conductive polymer solution and the inorganic solid state electrolyte in the Third step—III in the above mentioned invention.

The purpose of this invention is to achieve more preferably by providing a manufacturing process of a rechargeable battery as claimed in claim 1, wherein processing in drying is carried out at not more than 120° C. for 5 minutes to not longer than one hour after impregnating in filling or after coating the conductive polymer solution to the positive and negative electrodes in the Second step—II in the above mentioned invention.

The purpose of this invention is to achieve more preferably by providing a manufacturing process of a rechargeable battery, wherein at least one kind of the conductive binder and the conductive polymer are made by polymeric conductive composition obtained by graft polymerizing or living radical polymerization of a molten salt monomer having a polymerizable functional group and having an onium cation and an anion containing a halogen with a fluoro polymer in the above mentioned invention.

The purpose of this invention is to achieve more preferably by providing a manufacturing process of a rechargeable battery, wherein the ionic liquid is a molten salt having an onium cation and an anion containing a halogen, and the charge transfer ion source is lithium charge transfer ion source, and the conductive polymer having a lamellar structure is formed in the heating process in the Fourth step—IV in the above mentioned invention.

The purpose of this invention is to achieve more preferably by providing a manufacturing process of a rechargeable battery, wherein the inorganic solid state electrolyte is at least one kind selected material from the group consisting of Garnet, NASICON type crystal structure in oxide materials, a perovskite-type material and sulfide materials in the above mentioned invention.

The purpose of this invention is to achieve more preferably by providing a manufacturing process of a rechargeable battery, wherein a polyether type polymer is contained in at least one layer selected from the group consisting of the coating layer comprising a conductive polymer and an inorganic solid state electrolyte, the membrane comprising a conductive polymer and an inorganic solid state electrolyte, the positive electrode layer and the negative electrode layer in the above mentioned invention.

In this invention by containing an inorganic solid state electrolyte in the positive electrode and/or in the negative electrode comprising an active material, a conductive agent and an ion conductive binder, the purpose of this invention is more preferably achieved. Further in this invention by using a paste material comprising a conductive polymer powder, an ionic liquid and a charge transfer ion source, as a conductive polymer casting slurry, the purpose of this invention is more preferably achieved

### Advantage of the Invention

According to this invention a rechargeable battery incorporated either of electrodes and an inorganic solid state electrolyte layer in integral molding can be obtained in extremely competitive cost, and further, as apparent from the later mentioned Practical Examples, a rechargeable battery no occurring dendrite and restraining a grain boundary resistance between a positive and a negative electrodes to the fullest can be obtained. Furthermore, in feasible a cell formation obtaining a thinner cell thickness and less dependence on operational temperature and also in accidental short circuit the safety maintained excellently, the conductive polymer of inorganic solid state type rechargeable battery can be obtained nevertheless without a separator part.

Also, in case of utilizing Lithium metal foil as an anode part high performance of rechargeable battery having an excellent energy density feasible from the superior capacity and thinner cell thickness can be obtained. Furthermore, in case of coating a polyether polymer, for instance, allyl glycidyl ether polymer on surface of Li metal foil as the anode part the rechargeable battery could avoid occurring a dendrite by rendering a stabilization against reduction and oxidization (REDOX) reactivity. Further also, in restraining dendrite a membrane forming with a lithium nitrate (LiNO₃) on surface of lithium metal foil was known with a primary battery. This method is also effective in this invention.

Especially in case of utilizing sulfide type solid state electrolyte Li transfer number can be improved by coating non-proton material on the surface of the particles for a film-forming,

### BRIEF EXPLANATION OF FIGURES

FIG. 1 SEM photograph (Magnification 1000)
Surface of the closed pack structure

FIG. 2 SEM photograph (Magnification 1000)
Cross section of the closed pack structure

FIG. 3 SEM photograph (Magnification 5000)
Photograph of settlement point of bonding part between the active material particles,
and this bonding part is made in elasticity construction

FIG. 4 Nyquist Plot

FIG. 5 (a) The First step—I of preparing a positive electrode having the closed pack structure and a negative electrode in the same.
(b) The Second step—II of impregnating a conductive polymer to those electrodes.
(c) The Third step—III of overlaying in pressing an ion conductive polymer-inorganic solid state electrolyte on the electrode
The thermal control step—IV of heating the electrode.

FIG. 6 The Fifth step—IV of roll-pressing the overlaying electrodes with the electrolyte.

FIG. 7 (a1) The step of coating polyether type polymer on a surface of lithium metal foil as the negative part.
(a2-1) The step of heat-press extruding the gel form paste comprising a conductive polymer powder, an ionic liquid and an charge transfer ion source.
(a2-2) The step of UV curing.

### PREFERRED EMBODIMENT OF THE INVENTION

This invention is to achieve by providing a manufacturing process for a rechargeable battery consisting of at least 70% of the closed pack structure of positive and negative electrodes required in the process—I, in the coating layer with the casting slurry comprising a conductive polymer and an inorganic solid state electrolyte or placing a membrane comprising a conductive polymer and an inorganic solid state electrolyte between positive and negative electrodes, To achieve the purpose of this invention, in particular for obtaining the high performance of rechargeable battery refrained an interfacial resistance of the active materials' particles it is effective to treat preliminarily coating a conductive polymer interface-coating agent (e.g. Product code number CA400AM ex. Piotrek Co., Ltd.) so as to be feasible in stabilizing the ionic charge-transfer in LiNiCoMn having 60% of Ni element as an active material because such LiNiCoMn material has high pH (not less than 10) and also it is easy to occur Ni oxides in the surface of the particles. The voids of closed pack structure are fulfilled at least 70%, preferably more than 80%, most preferably over 90% with the coating agent. A filling rate in voids of the closed pack structure is calculated from the clearance rate obtained by volume distribution of the particle density obtained from the surface area and the cross section by Scanning microscope. As a process for forming the closed pack structure having at least 70% of void filling rate, an utilization of planetary centrifugal stirrer or revolution-rotation stirrer is preferred in a practical process, of which operational conditions are of 0 to 35 rpm of revolution and 0 to 60 rpm rotation as one of recommendation. In case of utilizing a biaxial revolution-rotation, it is recommendable to use a model of biaxial stirrer having a function individually settable of the speed on revolution and rotation. In any method of those stirring conditions, it is maintained temperature at not less than 50° C. for 5 to 30 minutes number of revolution at 500 to 1000 rpm and the rotation at 1000 to 2500 rpm in addition of operating the vacuum atmospheric pressure under an operation range changeable like 0 to 1 k Pa at 100 Pa for 3 to 5 minutes. For example, biaxial stirrer {Model: Kakuhunter 350-TV} as described in Japanese Patent No. 6232151 (Shashin Kagaku Co., LTD) and No. 6388992 (the same company) are related. Further as a process for forming a density filled construction having at least 70% of the voids of closed pack structure (voids: pore and porous), roll pressing process by biaxial roll multi stage press apparatus which can be heated at not less than 40° C. is preferable in practical use. Further also, a process of utilizing a batch formula in heat pressing the electrode filled with the conductive polymer material can be utilized in vacuum drying process 60 to 100° C. at 50 to 200 Pa as a vacuum condition, more preferably 70 to 90° C. at 100 to 150 Pa. The combination of these processes is raised also as a preferable method.

In this invention the positive electrode having the closed pack structure is a good embodiment, but also both of the positive and negative electrodes having the closed pack structure is acknowledged as the preferable embodiment. An ion conductive binder and a conductive polymer used for the positive and negative electrode are also used with conventional polymer such as a partially cross linked polyvinylidene fluoride but it is most preferable to utilize the conductive polymer described above, forming the closed pack pore and porous structure layer of electrodes with point bonding construction among particles of active material and solid state electrolyte material with the conductive polymer. And the addition of inorganic solid state electrolyte is also a preferable embodiment. In case of formulating inorganic solid state electrolyte in electrodes, the volume ratio of the inorganic solid state electrolyte is recommended at 5 to 50 wt. % toward total volume of active materials and conductive agent and at 10 to 30 wt. % ratio more preferably. Furthermore, a dispersant and other additives can be formulated application by application. In case of manufacturing a positive electrode, the total volume of an active material and a conductive agent is conventionally not less than 95 wt. % but in case of utilizing the ion conductive binder in use is feasible to use by 50 to 70% of conductive agent volume to make a conductive adhesive and in the process of making a electrode coating slurry the volume shall be adjusted by the test result of bonding force to optimize the volume of ion conductive binder like addition of more 10 wt. % in an insufficient bonding force. In calculation of the recipe the reduction rate of binder ratio should be increased volume of active material as a balance of 100 wt. %. Besides, the electrodes coating slurry shall be controlled the optimum rheology by measuring NV (Non Volatile Organic Compound) value and prepared a coating slurry of the closed pack voids electrodes for coating, and completed manufacturing the closed pack voids electrodes having high performance conductive network structure. On the other hands, in case of manufacturing negative electrode a negative electrode the surface square on average particle size of the negative electrode is one of critical index to make optimum recipe of the electrode formula, the necessary volume of the conductive agent should be determined by calculating a volume of the conductive agent through calculating the amount of solvent absorbed NMP (N-methyl pyrrolidone) into the anode active material in advance. By making firm the volume ratio in a same manner with the positive electrode, Upon prepared a coating slurry of the closed pack voids electrodes for coating, and completed manufacturing the closed pack voids negative electrodes having high performance conductive network structure.

In the Second step—II, the conductive polymer solution as this composition comprising a lithium charge transfer ion source to the ion conductive polymer is impregnated in filling to or coated to make a thin layer on the closed pack voids structure of positive and/or negative electrodes obtained in the First step—I. Then the electrodes are dried at not more than 120° C., preferably 40 to 100° C. for 5 minutes to 1 hour, more preferably 5 to 40 minutes. In case of impregnating in filling to or coating on the electrodes, it is preferable that the concentration of the conductive polymer solution is changed in multi stages, e.g. in the former stage of the concentration at 5 to 15 wt. % solution and in the latter stage at 20 to 50 wt. % solution. In this case, the conductive polymer fulfilled and surface film forming electrodes are obtained and achieved to perform restraining a grain boundary resistance from formation of a flat-surface in a thin film by fulfilling the conductive polymer through vacuum impregnating to the voids of the electrodes. As the process of impregnating the conductive polymer solution to the positive and/or the negative electrodes, for example, a process of vacuum impregnating and fulfilling a conductive polymer solution with the concentration at 5 to 15 wt. %, preferably 7 to 12 wt. % to voids of the positive and/or the negative electrodes can be obtained to form a hetero bonding structure achieving to refrain remarkably the grain boundary resistance on surface of the particles in the electrodes' layer. Next, by this process the electrode restraining a grain boundary resistance is obtained. Further, a process of forming a flat thin film on the electrodes by increasing the concentration at 20 to 50 wt. % of the conductive polymer and filling it under a heat press operation in multi stages is preferably achieved. The multi stages mean at least 2 heat press stages filling by changing the concentration of the conductive polymer in stage by stage. It is the most preferable to fill fully at least 70% of voids' rate of the closed pack structure electrodes. Further as a process of surface coating the conductive polymer, and upon finishing the impregnation and filling to voids of the electrodes and also as a process of forming a thin film in a thickness at a sub-microns order by coating a low concentration of the conductive polymer is adaptable in practical use. In those processes, the former method of impregnation and fulfilling is more preferable for achievement of the purpose to enhance maximizing the performance of electrodes in the excellent conductive performance of the overall solid state electrolyte LIB as one of practical applications of this invention. As a solvent in this application, acetone and acetonitrile are preferable, and G-BL (Gamma-Butyrolacetone) and tetrahydrofuran (THF) are also preferable depending on the selective kind of inorganic solid state electrolyte. The ratio concentration of ion conductive polymer is calculated as the volume of the conductive polymer in the total volume of the solution×100 in wt. % unit.

For achieving the purpose of this invention, in the process—II after impregnating in filling to or coating with the conductive polymer on the electrodes treat at not more than 100° C. under the vacuum force at less than 10 KPa, it is preferable to dry at not more than 120° C. for 5 minutes to 1 hr. In case of vacuum impregnating, it is preferable to utilize the multi stages method as mentioned above. The concentration of the conductive polymer in stage of vacuum impregnating in filling is the same as the impregnating process described above. The vacuum impregnating method is not only at batch system but also preferably at a continuous processing system. In case of the continuous system, it is more preferable to utilize through a buffering zone, a vacuum processing zone and a buffering zone and some more zones in order. In process of impregnating in filling or vacuum impregnating, it is preferable to inspect to search the optimum impregnated and filled states, that is, the bonded and filled states such as the conductive polymer rate covering on particles of electrodes' active material, and to establish the best conditions by taking SEM photograph of cross section and analyzing the data. The impregnating and filling process means of impregnating the conductive polymer to reach until the interior of the electrodes such as the positive and the negative electrodes and filling it in the voids of the electrodes layer and forming uniformly film on surface of the particles. In this film forming, it is effective to make the film formation by carrying out UV curing by adding 0.5 to 8.0 wt. % of UV curing agent based on the volume of the conductive polymer and irradiating in multi stages at the light intensity of 10 to 40 mW/cm² for 1 to 10 minutes.

In this invention it is critical factor of the total invention's content to integrally mold by coating the slurry consisting of conductive polymer and inorganic solid state electrolyte material on surface of the positive and/or the negative electrodes obtained by the Second step—II, which is the Third step—III In the process of coating the slurry consisting of the conductive polymer and the inorganic solid state electrolyte, it is preferable to prepare the casting slurry by adding the inorganic solid state electrolyte to a solvent solution of the conductive polymer and to coat this slurry on the surface of the positive and/or the negative electrodes so as to make the thickness in 1 to 30 μm, preferably 5 to 20 μm, preferably to form the uniform thickness by coating the casting slurry solution defoamed completely.

In case of inspecting the stability on the interface of the particle and rendering the influence to the conductive matrix composition materials by the inherent pH of the particle and the oxidation-reduction (REDOX) resistance, it is effective to make the film formation by the conductive polymer coating agent (e.g. TREKLITE CA300SE ex. Piotrek Co., Ltd.) to the surface of the particles of solid state electrolyte particle (e.g. LiLaZrTaO, LiLaZrAlO, LiPS, LiSO etc.), or to pre-treat by making a film formation on the surface of the active material electrode. As the coating method, a comma coating process, a die coating process, a bar coating process, an UV curing process and a blade coating process and the like are raised. In particular, a die coating method is preferable. Further a method of adding inorganic solid state electrolyte to solvent solution of conductive polymer, making a conductive membrane by using the solution, and then laminating under pressure to be bonding it on the surface of the positive and/or the negative electrodes is also raised. It is preferable to use a paste form of compound containing a molten salt as described later and additive agents such as lithium salt supporting agent, ionic liquid and so on to the powder form of conductive polymer in use also.

It is important to heat the positive and/or the negative electrodes having a layer consisting of conductive polymer and inorganic solid state electrolyte as obtained in the Third step—III at 60 to 100° C. for 5 to 60 minutes, which is the Fourth step—IV. an integral molding consisting of the conductive polymer and inorganic solid state electrolyte and the positive and/or the negative electrodes having the closed pack voids structure can be completed. It is preferable to heat the integral mold cell at 70 to 90° C. for 5 to 30 minutes in the dryer locating in a drying room under a cloudy point controlled. The heating condition is preferably controlled at 70 to 85° C. for 10 to 25 minutes. According to this heating treatment, the battery cell having a uniform conductive network forming a lamellar structure in the electrolyte layer and having the most excellent conductivity to perform an excellent ion transfer rate is obtained. This electrolyte layer formed the lamellar structure holds a stabilized conductivity in the range of −40° C. to 150° C., and an excellent lithium ion transfer in accordance with the stabilized conductive network without any dripping of formulated liquid solution can be achieved. In particular. ion conductivity in the range of −20° C. to 110° C. can be upgraded the ion conductive polymer electrolyte containing inorganic solid state electrolyte oxides at 10⁻⁴ S/cm as the inherent ion conductivity into at 10⁻³ ion conductivity of that ion conductive polymer. Finally by the Fifth step—V of laminating the positive electrode obtained by the Fourth step—IV with the negative electrode, a rechargeable battery having the layer consisting of a conductive polymer and inorganic solid state electrolyte can be obtained in practical application. By laminating the positive electrode with the negative electrode on the both sides of layer consisting of the conductive polymer and the inorganic solid state electrolyte or the membrane comprising conductive polymer and the inorganic solid state electrolyte, and then roll-pressing it to make a rechargeable battery cell having the positive electrode with the conductive polymer, the inorganic solid state electrolyte or its membrane with the negative electrode. The temperature in laminating them is good at ambient temperature, but preferably at 40 to 90° C., most preferably at 50 to 80° C. in the heat-drying process.

By making a battery cell having the conductive polymer with the inorganic solid state electrolyte integrally molded in a roll form, a winding cell type of rechargeable battery is obtained in operation of a winder machine. And then by using stack assembly machine, a stack type of rechargeable battery can be obtained.

By integral molding of the conductive polymer with inorganic solid state electrolyte and forming it into 1 mm smaller at size of positive half cell than the length wise and the cross wise of negative half cell, short circuit of the positive and negative electrodes can be prevented. Further by using polyimide insulation seal covering on electrode terminal, short circuit can be also prevented. In such an integral molding on negative electrode a rechargeable battery can be obtained in efficiently manufacturing process.

Further by using the positive and/or the negative electrodes with the voids, the slurry consisting of the conductive polymer and the inorganic solid state electrolyte are filled into those voids. As those advantages, a rechargeable battery having a restrained grain boundary resistance and also an excellent performance can be obtained. In these positive and negative electrodes they are necessarily used a collector, respectively.

In this invention it is preferable embodiment to laminate the positive electrode having the conductive polymer and the inorganic solid state electrolyte with the negative electrode of lithium metal foil to in the one side or both sides of which polyether type

polymer containing LiNO₃ is coated, which is the Fifth step—V.

In this invention as the conductive polymer used in the steps of—I, —II and —III various conductive polymer are raised. The following polymeric conductive composition is the most preferable.

First, polymeric conductive composition (X¹) obtained by graft polymerizing or living radical polymerization of a molten salt monomer having a polymerizable functional group and having an onium cation and an anion containing a halogen with a fluoro polymer is mentioned below.

As a fluoro polymer used by graft polymerization or living radical polymerization, a polyvinylidene fluoride polymer or copolymer are preferably raised.

The polyvinylidene fluoride copolymer, a copolymer having a unit of vinylidene and a unit specifying

Formula: —(CR¹R²—CFX)—

In formula, X is of halogen atom except fluorine atom.

R¹ and R² are hydrogen atom or fluorine atom, each is same or different atom, halogen atom is chlorine atom as the best, bromine atom or iodine atom also.

This co-polymer having

Formula: —(CR³R⁴—CR⁵F)ₙ—(CR¹R²—CFX)ₘ—

In formula, X is of halogen atom except fluorine atom.

R¹, R², R³, R⁴ and R⁵ are hydrogen atom or fluorine atom, each is same or different atom

“n” is 65 to 99 mol %, “m” is 1 to 35 mol %.

is preferred and the best co-polymer is

Formula: —(CH₂—CF₂)ₙ—(CF₂—CFCl)ₘ—

In formula, “n” is 99 to 65 mol %, “m” is 35 to 1 mol %.

In case that “n” plus “m” is of 100 mol %, it is preferred to formulate “n” in 65 to 99 mol % and “m” in 1 to 35 mol %. The better formula is “n” in 67 to 97 mol % and “m” in 3 to 33 mol %. The best formula is “n” in 70 to 90 mol % and “m” in 10 to 30 mol %.

The said co-polymer is of block polymer or random co-polymer. And other monomers obtaining co-polymer are also utilized in a range of conforming to the purpose of this invention.

The molecular weight of the said polymer is 30,000 to 2,000,000. better as a mean molecular by weight. And the more preferred molecular by weight is 100,000 to 1,500,000. The mean molecular by weight is calculated based on the intrinsic viscosity [η] in an estimated formula.

In case of proceeding a graft polymerization of a molten salt monomer with the said co-polymer, it is adaptable an atom transfer of radical polymerization with transition metal complexes. This transition metal positioning on the complex become a trigger by pulling out halogen atom such as chlorine atom except fluorine atom, and the molten salt monomer on the said polymer is graft-polymerized with the said co-polymer. Further a homo polymer of vinylidene fluoride is used.

It is preferable in this invention to make a graft polymerization at range between 2 and 90 mol %, in adjusting the recipe of polymer structure at 98 to 10 mol % as monomer unit and 2 to 90 mol % of the molten salt monomer to meet plastic physical properties aimed as the controlling target. These graft polymers are obtained by the methods as described in the prior art, WO2010/113971.

In this invention, a molten salt monomer having a polymerizable functional group and having an onium cation and anion containing a fluorine with a fluorine containing a polymer of which salt structures are related onium cation having an aliphatic, an alicyclic, an aromatic or a heterocyclic radical, and anion containing fluorine as preferred.

This onium cation means ammonium cation, phosphonium cation, sulfonium cation, onium cation, or guanidium cation. As an ammonium cation, quaternary ammonium cation, heterocyclic ammonium cation such as imidazolium cation, pyridinium cation and piperidinium cation. It is preferred the salt structure consisting of ammonium cation at least one kind selected from ammonium cation group as described below and anion at least one kind selected from anion group as described below.

Ammonium Cation Group:

Pyrrolinium cation, pyridinium cation, imidazolium cation, pyrazolium cation, benzimidazolium cation, indolium cation, carbazolium cation, quinolinium cation, pyrrolidinium cation, piperidinium cation, piperazinium cation, alkylammonium cation including substituted with alkyl, hydroxyalkyl or alkoxy alkyl radicals having 1 to 30 carbon atoms (for example 1 to 10 carbon atoms). These are connected hydrocarbon radicals having 1 to 30 carbon atoms (for example 1 to 10 carbon atoms), hydroxyalkyl or alkoxyalkyl radicals on N and/or cyclic radical of the ammonium cation.

Phosphonium Cation Group:

Tetra alkyl phosphonium cation (for example 1 to 30 carbon atoms), trimethyl ethyl phosphonium cation, triethyl methyl phosphonium cation, tetra amino phosphonium cation, trialkyl hexadecyl phosphonium cation (alkyl having 1 to 30 carbon atoms), triphenyl benzyl phosphonium cation, phosphonuim derivatives having three alkyl groups in which each alkyl has 1 to 30 carbon atoms. Hexyl trimethyl phosphonium cation, asymmetry trimetyl octyl phosphonium cation,

Sulfonium Cation:

Trialkyl sulfonium cation, diethyl metyl sulfonium cation, dimethyl propyl sulfonium cation, asymmetric sulfonium of dimethl hexyl sulfonium.

Anion group containing halogen atom:

As the anion group containing halogen atom, anion group containing fluorine, anion group containing chlorine atom, anion group containing bromine atom are raised. Among them, anion group containing fluorine is more preferable to achieve the desired object of this invention

BF₄⁻, PF₆⁻, CₙF₂ₙ₊₁CO₂⁻ in n=1 to 4 as an integer whole number, CₙF₂ₙ₊₁SO₃⁻ in n=1 to 4 as an integer whole number, (FSO₂)₂N⁻, (CF₃SO₂)₂N⁻, (C₂F₅SO₂)₂N⁻, (CF₃SO₂)₃N⁻, CF₃SO₂—N—COCF₃⁻, R—SO₂—N—SO₂CF₃⁻ wherein R is aliphatic group, ArSO₂—N—SO₂CF₃⁻ wherein Ar is aromatic group, CF₃COO⁻ and its same group containing halogen atom, are raised.

Polymeric radicals of the monomer are indicated C—C unsaturated radicals such as vinyl, acryl, methacryl, acrylamide, allyl radicals and its same group, cyclic-ether group as epoxy, oxetane radicals and its same group, cyclic-sulfide group such as tetrahydrothiophene or isocyanate radical and its same group.

(A) Ammonium cation group having polymeric radicals preferred particularly include

Trialkyl aminoethyl methacrylate ammonium, trialkyl aminoethyl acrylate ammonium, trialkyl amino propyl acryl amido ammonium, 1-alkyl-3-viny imidazolium,

4-vinyl-1-alkylpyridinium, 1-(4-vinylbenzyl))-3-alkyl imidazolium,

2-(methacryloyloxy) dialkyl ammonium, 1-(vinyl oxyethyl)-3-alkylimidazolium,

1-vinyl imidazolium, 1-allylimidazolium, N-alkyl-N-allyl ammonium,

1-vinyl-3-alkylimidazolium, 1-glycidyl-3-alkyl-imidazolium,

N-allyl-N-alkyl pyrrolidinium or quaternary diallyl dialkyl ammonium cations.

All alkyls therein contain 1 to 10 carbon atoms.

(B) Anion group containing fluorine, preferred particularly, include bis (trifluoro methyl sulfonyl) imide anion, bis (fluoro sulfonyl) amide anion,

2,2,2-trifluoro-N-{(trifluoromethyl)sulfonyl}acetoamide anion,

bis{(pentafluoro) sulfonyl}imide anion, tetra fluoroborate anion, hexafluorophosphate anion, trifluoro methane sulfonyl imide anion and its same group. Anions having halogen atom therein are more preferred.

Besides, the molten salt monomer as salt of cation and anion group described above are most preferably included

trialykyl aminoethyl methacrylate ammonium bis (fluoro sulfonyl)amide,

2-(methacryloyloxy) dialkyl ammonium bis(fluoro sulfonyl)amide, wherein alkyl is C₁ to C₁₀ alkyl, N-alkyl-N-allyl ammonium bis (trifluoro methyl sulfonyl) amide wherein alkyl is C₁ to C₁₀ alkyl, 1-vinyl-3-alkylimidazolium bis(trifluoro methyl sulfonyl)amide wherein alkyl is C₁ to C₁₀ alkyl, 1-vinyl-3-alkylimidazolium tetrafluoroborate wherein alkyl is C₁ to C₁₀ alkyl, 4-vinyl-1-alkyl pyridinium bis(trifluoro methyl sulfonyl)amide wherein alkyl is C₁ to C₁₀ alkyl, 4-vinyl-1-alkylpyridiium tetra fluorate wherein alkyl is C₁ to C₁₀ alkyl, 1-(4-vinylbenzil)-3-alkylimidazolium bis{(trifluoro methyl sulfonyl) amide wherein alkyl is C₁ to C₁₀ alkyl,

1-glycidyl-3-alkyl-imidazolium bis{trifluoromethyl}sulfonyl}amide wherein alkyl is C₁ to C₁₀ alkyl, trialkyl amino ethyl methacrylate ammonium trifluoro methane sulfonyl amide wherein alkyl is C₁ to C₁₀ alkyl, 1-glycidyl-3-alkyl-imidazoliium tetrafluoroborate wherein alkyl is C₁ to C₁₀ alkyl, N-vinyl carbazolium tetrafluoroborate wherein alkyl is C₁ to C₁₀ alkyl and its same group. Those molten salt monomer is utilized one kind or more than two kinds. These molten salt monomers are obtained by the methods as described in the prior art of WO2010/113971.

Graft ratio of the molten salt monomer on the co-polymer described above is preferred in the range of 2 to 90 mol %, more preferred 10 to 85 mol % and the most preferred 20 to 80 mol %. In the lower range of graft ratio, for example, 2 to 40 mol %. preferably 5 to 35 mol %, more preferably 5 to 30 mol % the flexibility such as sponge is obtained, and further an adhesive strength, an elasticity can be improved better. In the higher range of graft ratio, for example, 40 to 90 mol %. preferably 45 to 85 mol %, more preferably 50 to 80 mol %, an adhesive strength is improved better due to the increase of a viscoelasticity, and further a pressure sensitive adhesive strength, an anti-cracking property, a dispersing property of particles such as pigment, a stability on PH, a stability on temperature and a conductivity can be improved better. In case of using this as a conductive polymer, 2 to 90 mol % of graft ratio is used. And in case of using this as an ion conductive binder, 5 to 50 mol % of low graft ratio is used.

This graft polymerization of the molten salt monomers is preferred either sole or co-polymerization of the molten salt monomer with other monomers making co-polymerization with the molten salt monomer.

In polymeric conductive composition (X¹), SEI (Solid Electrolyte Interphase) such as Vinylidene carbonate, vinylene acetate, 2-cyanofuran, 2-thiophenecarbonitrile, acrylonitrile, membrane forming material or solvents can be contained.

In this invention, by adding the conductive polymer or ion conductive binder which is the polymer electrolyte (X¹) composition to ionic liquid (X²), the conductive polymer matrix is preferably obtained. By using this conductive polymer matrix, the lamellae structure is formed, and the conductivity and its durability are improved better.

Herein as an ionic liquid (X²), one having an onium cation and an anion containing halogen, especially the above mentioned molten salt having ammonium cation group and anion group containing halogen are preferable.

For example, various ionic liquids such as cyclic conjugated ionic liquid sharing a cation with two nitrogen, noncyclic aliphatic ionic liquid containing alkylammonium or phosphonium, cyclic aliphatic ionic liquid containing quaternary ammonium, or pyrrolidinium are raised.

Specifically, 1-ethyl-3-methyl imidazolium bis (fluoro methane sulfonyl) amide (EMI.FSI), ethyl-3-methylimidazoliumbis(trifluoro methane sulfonyl) amide (EMI.TFSI),

1-butyl-3-methylimidazoliumbis(fluoro methane sulfonyl) amide (BMI.FSI),

1-methyl-1-butyl pyrrolidiun bis(fluoro methane sulfonyl) imide (MBPy.FSI) and so on are raised preferably.

Further as a ionic liquid (a molten salt), a monomer having onium cation and anion containing halogen and polymerizable functional group is raised, and as the monomer, the abovementioned molten salt monomer used in the graft polymerization is raised.

The amount of polymeric conductive composition (X¹) is 5 to 90 wt. %, preferably 50 to 80 wt. % based on the total amount of the polymeric conductive composition (X¹) and ionic liquid (molten salt) (X²).

In this invention, by the addition of a charge transfer ion source (supporting salt) the conductivity and durability of conductivity are preferably improved. Herein as an charge transfer ion source lithium salt is typically utilized wherein it is more preferred lithium salt consisting of lithium cation and anion having fluorine atom.

As the ion transfer sources the following salts such as lithium salt are raised;

LiBF₄, LiTFSI, LiPF₆, CₙF₂ₙ₊₁CO₂Li wherein n=1 to 4 is an integer whole number,

CnF₂ₙ₊₁SO₃Li wherein n=1 to 4 is an integer whole number, (FSO₂)₂NLi (LiFSI), (CF₃SO₂)₂NLi (LiTFSI), (CF₃SO₂)₃NLi, (C₂F₅SO₂)₂NLi, (FSO₂)₂CLi, (CF₃SO₂)₃CLi, (C₂F₅SO₂)₃NLi, (CF₃SO₂—N—COCF₃)Li, Li(R—SO₂—N—SO₂CF₃) wherein R is aliphatic such as alkyl or aromatic group), (C—N)₂CₙF₂ₙ₊₁ Li wherein n=1 to 4 is an integer whole number). Further, as an ion transfer source except lithium salt, stannic tin indium oxide (TIO), carbonate salt is raised.

The amount of the above charge transfer ion sources based on the amount of polymer electrolyte composition (X²) is 0.5 to 60 mol %, preferably 0.7 to 50 mol %.

The various solvents are used in the polymer electrolyte composition. As the solvent, dimethyl sulfoxide (DMSO), N-methyl pyrrolidone, dimethyl acetoamide, acetone, acetonitrile, THF and mixture thereof are raised. Those conductive polymers are produced by the method as described in line 5, page 3 to line 24, page 9 of PCT/JP2018/018439 (basic Japanese patent application No. 2018-22496).

In this invention in case of producing the negative electrode water soluble binder is used, and as the water soluble binder polyvinyl alcohol, a copolymer of ionic liquid having a polyfunctional group such as 2-(methacryloyloxy) ethyl trimethyl ammonium-anion (MOETMA-Anion), diallyl dimethyl ammonium-anion (DAA-Anion), 1-ethyl-3-vinylimidazolium-Anion (EVI-Anion) are used. As this anion, BF4 is preferred.

Further watersoluble ion conductive binder produced by using a copolymer of stylene-butadiene or carboxy methyl cellulose copolymer and ionic liquid is also preferred, in this Case water soluble supporting dispersant such as a polyvinyl pyrrolidone (PVP).

In order to improve the film-character, CMC can be added. By using these water soluble ion conductive binder, the closed pack structure can be formed preferably.

The inorganic solid state electrolyte used in the composition of this invention is described in the following.

As the inorganic solid state electrolyte, Garnet material, NASICON type crystal structure, perovskite-type material and sulfide material are used. As Garnet material is more preferable among them, first the Garnet material is explained. As the Garnet material, oxide solid electrolyte such as LLZO, LLTO, are raised more preferably.

Further as the NASICON type crystal structure materials in the inorganic solid state electrolyte, the LATP and the LAGP solid state electrolyte are indicated as examples as mentioned below. In particular, an oxidized material showing L_{i(1+X)}Al_{X}Ti_{(2-X)}(PO₄)₃ (X=0.1 to 1.5, preferably 0.1 to 0.8), e.g. Li_{1.4}Al_{0.4}Ti_{1.6}(PO₄)₃ and the like are preferable. Furthermore, Li_{(1+4X)}Zr_{(2-X)}(PO₄)₃(X=0.1 to 1.5, preferably 0.1 to 0.8) (Part of Zr can be substituted to at least one kind selected from the group consisting of Al, Ca, Ba, Sr, Sc, Y and In) is also raised. By adding this NASICON type crystal structure material to the polymeric conductive composition in practical use, the descending effect of particle interface resistance can be rendered.

As the LATP, Li₃PO₄, Li₄SiPO₄, Li₄SiPO₄—Li3PO₄, Li₃BO₄ are raised.

As the Perovskite type material of the inorganic solid state electrolyte, the oxide compound such as LaₓLi_{y}TiO_{z} and the like are raised. As the particle of this oxide compound, although nano-size (nm) or micron-size is used, the nano-size (nm) is more preferable to obtain better the descending effect of particle interface resistance than the effect with micron-size.

Further as the sulfide material (LPS), 75% Li₂S.25% P₂S₅, Li_{3.25}P_{0.95}S₄, Li_{3.2}P_{0.96}S₄, Li₄P₂S₆, Li₇P₃S₁₁, Li₆PS₅Cl, Li₃PS₄ and the like are raised. By using the sulfide material and the polymeric conductive composition concerned, the descending effect of particle and electrode interface resistances can be rendered and also the generation of toxic gas caused by the combustion accident due to case of short circuit and so on can be reduced.

In this sulfide material, toluene, hexane and tetrahydrofuran are used as non-polar soluble or dispersible solvent. By coating conductive agent (Trading No., CM2100 produced by Piotrek Co., Ltd and so on) on the surface of the sulfide material, the casting slurry with thus coating sulfide material particles is integrally molded with the electrode, or conductive membrane produced from the casting slurry of such sulfide material particles can be made the cell by molding in two layers formation with the electrode.

The inorganic solid state electrolytes as shown above are described in 9^{th} page 25^{th} line to 10^{th} page 26tth line of PCT/JP2018/018439 (basic Japanese patent application No. 2018-22496).

The casting slurry formulating ionic liquid (X²) and/or charge transfer ion resources to the conductive polymer solution produced by the Second step—II or the Third step—III, containing the inorganic solid state electrolyte, the purpose of the present invention can be obtained preferably.

The embodiment using a polyether polymer in a positive electrode, an electrolyte layer and a negative electrode is described in the following.

In this invention, this embodiment means forming a film as a buffer layer to restrain a generation of dendrite by coating, a polyether type polymer in the one side or both sides of the surface of lithium metal foil as the negative electrode part with collector, and forming a film by radiating for 1 to 5 minutes in using 0.5 to 8.0 wt. % of UV curing agent at 10 to 40 mW/cm² of light intensity toward the volume of conductive polymer or forming a film by thermosetting method.

As the polyether type monomer, partially crosslinked polyether polyol monomer is preferable, and a cross linked polymer of (1) a polyether polymer obtained by ring-opening polymerization 0f an allyl glycidyl ether with ethylene oxide and (2) polyether polyol poly(metha) acrylate acylated with (metha) acryl acid at the terminal of three functional polyether polyol by polymerizing glycerin with ethylene oxide is the most preferable. A molten salt and lithium salt are added to a copolymer of glycidyl ether having radical polymerizable allyl group in the side chain and alkylene oxide, and by heating it after formulating a molten salt and lithium salt are taken in the polymer matrix and .further, It is preferably of forming a buffer layer film to make coating the copolymer of polyether polymer obtained by ring-opening polymerization of an allyl glycidyl ether with ethylene oxide and a polymerizable ionic liquid, e.g., MOETMA-Anion, DAA-Anion, EVI-Anion and the like, on the surface of lithium metal foil. In this formulation, it is also effective to achieve the restrain of the dendrite occurring by adding 2 to 10 wt. % of lithium nitrate based on the volume of the conductive polymer to this conductive polymer.

The non-polar-polyether polymer as shown above is described in 34 line of page 10^{th} page 34^{th} line to 13^{th} page 1 line of PCT/JP2018/018439 (basic Japanese patent application No. 2018-22496). This polyether polyol as the basic material is used as a raw material copolymerized with ionic liquid.

By using these polyether type polymers, the property of oxidation-reduction (REDOX) resistance is improved well. In particular, in case of utilizing lithium metal foil as a negative electrode part, the stability property against oxidation-reduction (REDOX) operation is more effectively performed.

Furthermore, the polymeric conductive composition having 5 to 45 mole % of graft ratio obtained by graft polymerizing a molten salt monomer with a fluoro polymer is used in the positive and the negative electrodes as ion conductive binder and also the inorganic solid state electrolyte corresponding to the volume of 5 to 30 wt. % of the active material in the electrodes is effective as the substitute of the active material. By improving the compatibility of (1) the positive and/or negative electrodes and (2) the conductive membrane layer consisting of the conductive polymer and the inorganic solid state electrolyte, the internal resistance of rechargeable battery cell is restrained, and a charge transfer index of the Li+ ion transfer is efficiently improved also.

In this invention, the formulation ratio of the polymeric conductive composition and the inorganic solid state electrolyte, the volume of the inorganic solid state electrolyte is at 1 to 99 wt. % based on the total volume of the composition containing a supporting salt consisting of the polymeric conductive composition and the inorganic solid state electrolyte, and preferably 40 to 98 wt. % and also more preferably 60 to 95 wt. %.

In the lithium type metal compound as a positive electrode active material, the following compounds are raised as the example

LiCoO₂, LiNiO₂, LiFeO₂, LiMnO₃, LiMn₂O₄

Li₂Mn₂O₄, LiNi_{0.5}Mn_{1.5}O₄, LNi₁₃Mn₁₃O₂, LiFePO₄

LiCoPO₄, LiNiPO₄, LiMnPO₄, LiNi₈Co₁Mn₁

and the like

Further, upon use of the positive electrode a conductive agent is used in this electrode formulation. The conductive agent such as natural graphite, artificial graphite, hard carbon, MCMB (mesophase small sphere), nanoparticle carbon, carbon nanofiber (VGCF), and/or carbon nanotube (CNT) and the like are raised. As the partial substitute of the conductive agent, polymeric conductive composition may be used, and the polymeric conductive composition having a lower graft ratio may be used as a conductive binder.

As the negative electrode used in this invention, carbon material such as natural graphite, artificial graphite, hard carbon, MCMB (mesophase small sphere), LTO (lithium titanate) such as Li₄Ti₅O₁₂, silicon material such as SiO/graphite or lithium metal foil and the like are raised as the example. As the conductive agent, carbon black, acetylene black, hard carbon, nanoparticle carbon, carbon nanofiber (VGCF), and/or carbon nanotube (CNT) are raised but in case of utilizing lithium metal foil as the negative electrode part these conductive agent are not required. The active agent used in the negative electrode is the same as one used in the positive electrode or different from one used in the positive electrode. However, the active agent used in the negative electrode and the positive electrode is preferably different. The positive and negative electrodes as shown above are described in 13^{th} Page 23rd line to 14^{th} Page 31st line in PCT/JP2018/018439 (basic Japanese patent application No. 2018-22496).

In this invention, by using the inorganic solid state electrolyte and the polymeric conductive composition as a conductive polymer LIB cell can be obtained in no use of separator, so called, separator-less LIB can be obtained. However, it is no problem to use the separator in a specific application.

This invention is described and illustrated by the following Practical Examples.

### PRACTICAL EXAMPLE 1

First step—I Process for producing the positive electrode having the closed pack voids structure in the upper Drawing of FIG. 5(a)}.

By using the following materials, the composition for the positive electrode was obtained.

Active material: LiNi₈Co₁Mn₁ (NCM811);

Conductive agent: carbon black Super C65;

Ion conductive binder (X¹) [Trading No. CBC5410FP produced by Piotek Co., LTD: graft polymer (20 mol % of graft ratio) of a vinylidene fluoride copolymer {—(CH₂—CF₂)ₘ—(CF₂—CFCL)ₙ (m=96 mol %, n=4 mol %) utilized product name [Kynar] produced by ARKEMA} with a molten salt monomer (ionic liquid) {2-(methacryloyloxy) ethyl trimethyl ammonium bis (fluorosulfonyl) imide and processing aids.

2.5 wt. % of the conductive agent, 1.6 wt. % of solid content of ion conductive binder powder under wt. % unit based on 100 wt. % of the total volume of the active material, the ion conductive binder and the conductive agent were added to a container and mixed uniformly in the planetary centrifugal mixer for 10 minutes and then ion conductive adhesive powder was obtained. Further by adding desired N-methyl pyrrolidone (NMP) as the solvent, active material was immersed sufficiently and conductive adhesive slurry was obtained. Then the active material of LiNi₈Co₁Mn₁ was added and mixed uniformly in the planetary centrifugal mixer for 15 minutes and then the coating solution was obtained. After carrying out particle size distribution test, and then drip slide test to adjust the optimum rheology of the coating slurry. the positive electrode having the closed pack voids structure (at least 70% of closed pack formation rate) was obtained. Then, by taking a photograph of the and the surface and cross section of the electrodes by SEM observation, the closed pack structure was confirmed.

SEM photograph of the surface and the cross section and the bonding parts structure of particles (FIG. 1, FIG. 2 and FIG. 3), which photograph shows the closed pack voids structure:

In comparison with electro chemical characteristic test, IR drop and low temperature character were improved so much, and to achieve decreasing by 20% from 2.0 wt. % of ion conductive binder in the total coating solution, that is, 0.4 wt. % is effected to increase by the same volume from the volume of active material, and the use of ion conductive binder of electrode is helpful to improve the volumetric energy density.

### PRACTICAL EXAMPLE-2

First step—1 Process for producing the positive electrode having the closed pack voids structure in the Upper Drawing of FIG. 5(a).

By using the following materials, the composition for the positive electrode was obtained in the same way as Practical Example 1.

Active material: LiNi₈Co₁Mn₁ (NCM811);

Conductive agent: carbon black Super C65;

Ion conductive binder comprising [Trading No. CBC5430FP produced by Piotek Co., Ltd.] which comprised the same ion conductive binder as used in Practical Example 1 [Trading No. CBC5410FP produced by Piotrek Co., Ltd. and a dispersant];

The materials as shown above was added to a container and mixed uniformly in the planetary centrifugal mixer (Trading No. SK35T produced by Shashin Chemical Co., Ltd.) with revolution at 1000 rpm, with rotation at 1500 rpm, and then the electrode was obtained.

The obtained positive electrode having the closed pack voids structure (at least 70% of voids filled rate).

The conductive binder was prepared in half time in comparison with use of a planetary mixer for making a uniform coating slurry, and also decreasing by 20% wt. % as the volume of the binder was achieved. Further due to the increase of active material to meet the reduced volume of the binder the volumetric energy density was improved.

A process for producing a negative electrode having a closed pack voids structure which is shown in Down Drawing of FIG. 5(a). The volume of Conductive agent is determined especially dependent on the surface square rate of natural spherical graphite as negative electrode.

By determining the volume of an ion conductive binder (Trading No. CBA9230FP produced by Piotrek Co., LTD) according to the conditions of a surface area of the negative electrode, the desired coating solution was prepared. By formulating 70% of ion conductive binder to the volume of conductive agent in the same process, the negative electrode having a closed pack voids structure (at least 70% of voids filled rate) was produced.

### PRACTICAL EXAMPLE-3

Second step—II Process of filling the conductive polymer into voids of the positive electrode and of film-forming with the conductive polymer matrix {FIG. 5(b)}.

By adding the molten salt as ionic liquid kind and Li salt {bis (fluoro sulfonyl) imide lithium salt} (LiFSI) to the conductive polymer used in Practical Example-1, the conductive polymer filler composition (ICPm) was obtained. By impregnating the slurry solution in 10 wt. % of this conductive polymer to the positive electrode having the closed pack voids structure produced by step—I of Practical Example 1, and then increasing the concentration of the slurry gradually, the multi staged impregnating were carried out under condition of filling at least 80% of voids in the closed pack voids structure.

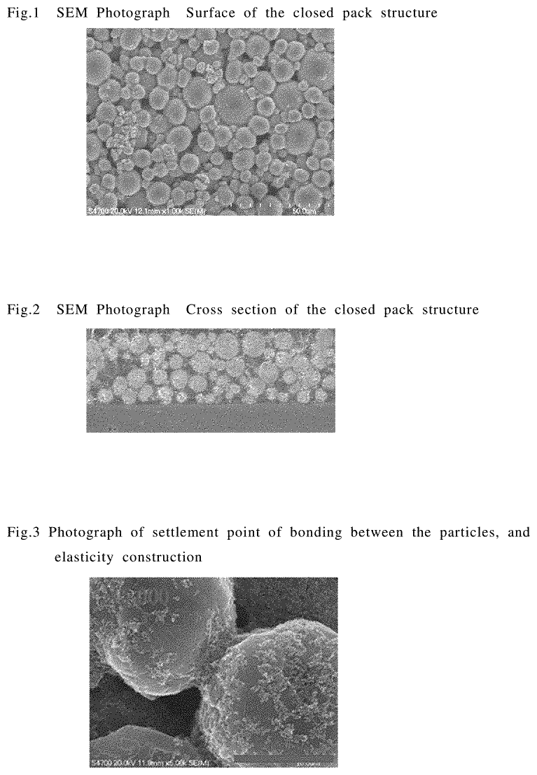

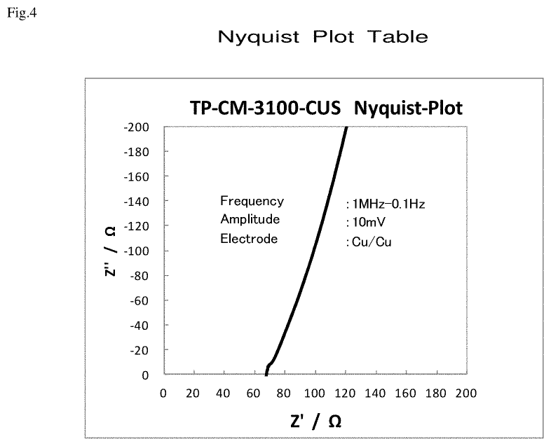

By observing the surface and the cross section of the conductive polymer filled electrode, the closed pack voids structure of at least 90% was confirmed. And then the solution of the conductive polymer matrix (Trading No. TP-CE2100 as one of Ion Conductive Polymer ex. Piotrek Co., Ltd.) was coated on the surface of the positive electrode. As the result the grain boundary resistance was reduced so much and the boundary resistance of not more than 100 Ω with Nyquist plot was obtained (FIG. 4).

### PRACTICAL EXAMPLE-4

Step—II Process of filling the conductive polymer into voids of the negative electrode and of film-forming forming conductive polymer matrix {FIG. 5(b)}.

By adding the molten salt as ionic liquid kind and Li salt (LiFSI) to the conductive polymer used in Practical Example-2, the conductive polymer-filling composition (ICPm) was obtained. By impregnating slurry solution of 10 wt. % of this conductive polymer to the positive electrode having the closed pack structure produced by step—II of the Example 2, and then increasing the concentration of the slurry gradually, the multi staged impregnating were carried out. By observing the surface and the cross section of the conductive polymer filled electrode, the closed pack structure of at least 70% was confirmed in the same way of the Example 3. And then the solution of the conductive polymer matrix (Trading No. TP-CE2100 ex. Piotrek Co., Ltd.) was coated on the surface of the positive electrode.

### PRACTICAL EXAMPLE-5

Step—II Forming reduction resistant film to Lithium metal foil as the negative electrode part.

By coating reduction resistant polyether polyol on the surface of the Lithium metal foil having the layer thickness at 30 μm, and thermosetting at 80° C. for 1 hour and the coated film having layer thickness of 10 μm was obtained. By forming this reduction resistant film as the buffer membrane, a stabilized electron transfer in lithium metal foil on cupper foil collector was achieved (FIG. 7).

### PRACTICAL EXAMPLE-6

Third step—III Manufacturing process of the casting slurry containing the conductive polymer matrix and the inorganic solid state electrolyte {FIG. 5(c)}.

As the inorganic solid state electrolyte of LAGP was selected in use among GARNET materials.

By adding ionic liquid {1-ethyl 3-methyl imidazolium bis(fluoro sulfonyl)imide} land Li salt (LiFSI) and LATG among NASICON type to the same kind of conductive polymer as used in Practical Example-1, the casting slurry was obtained. By coating this slurry to Teflon plate and then treating at 120° C. for 1 hour, the conductive membrane was obtained. After confirming the membrane having 1.6×10⁻⁴ S/cm. As the result of the hanging test for heat resistance at −40° C. to 150° C., no occurring of any drip and forming the lamellar structure of ionic liquid was confirmed.

### PRACTICAL EXAMPLE-7

Fourth step—IV By coating the casting slurry consisting of the conductive polymer matrix and the inorganic solid state electrolyte into voids of the negative electrode and curing at 80° C. for 30 minutes, the integral molded half cell having a smooth surface was obtained.

### PRACTICAL EXAMPLE-8

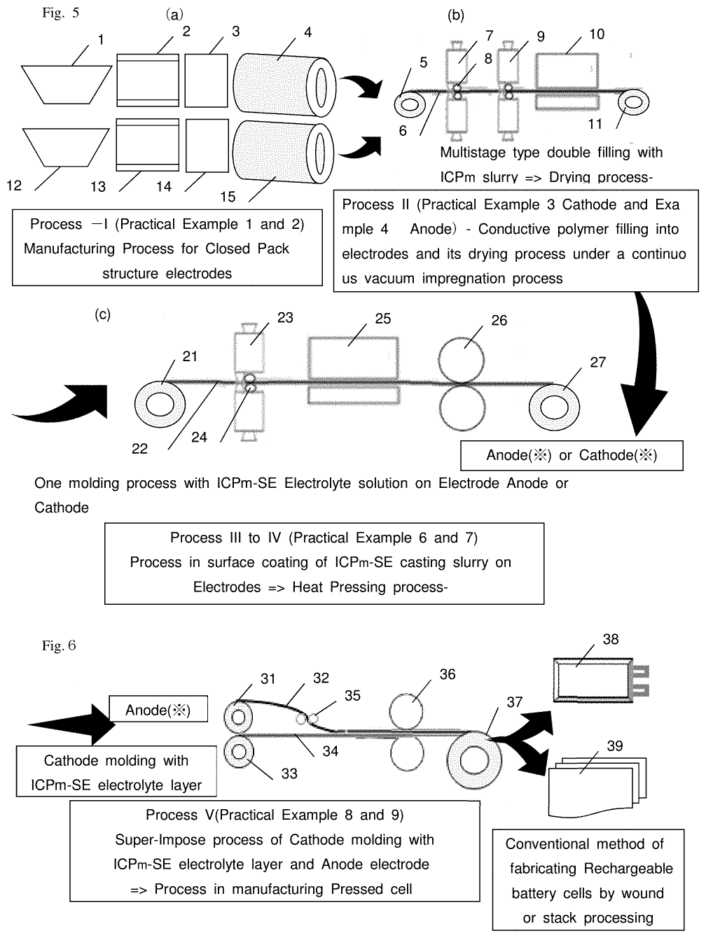

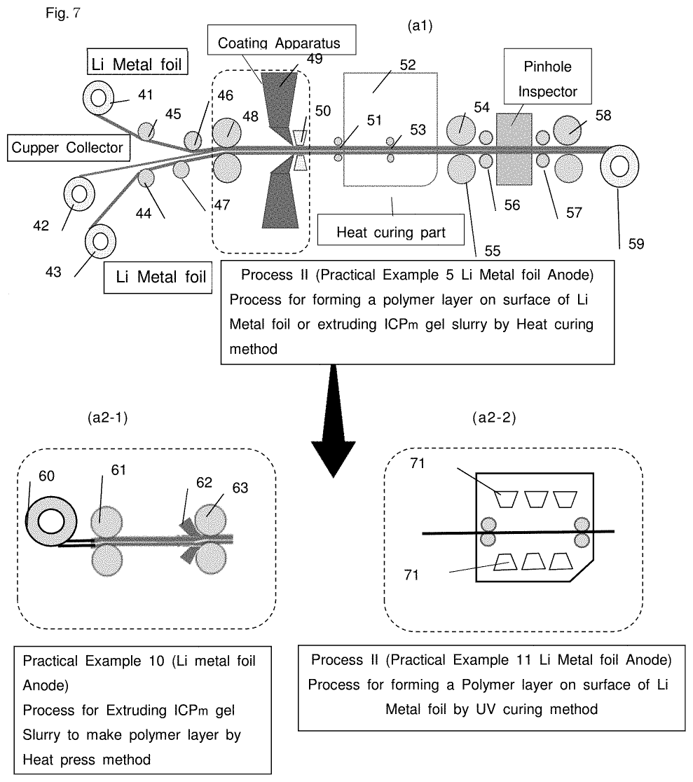

Fifth step—V By laminating integrally molded half cell consisting of the conductive polymer matrix and the inorganic solid state electrolyte (SE) and the negative electrode produced by step—IV, and the positive electrode having the closed pack voids structure filled with conductive polymer produced by step—II, and upon pressing by heat roll, an internal cell of solid state electrolyte rechargeable battery was produced (FIG. 6)

### PRACTICAL EXAMPLE-9

Fifth step—V Membrane was produced by using the conductive polymer matrix solution and the particles of the LiLZTao inorganic solid state electrolyte to the surface of which the conductive polymer coating material {Trading No. CE2100SE produced by Piotrek Co., Ltd.} was coated and then by inserting the membrane between the positive electrode and the negative electrode obtained in step—II and then by heat-pressing, the solid electrolyte chargeable battery was produced.

### PRACTICAL EXAMPLE-10

Fifth step—V A blend of conductive polymer powder {Trading No. G75CM311 produced by Piotrek Co., Ltd.}, Li salt (LiFSI) and a molten salt as ionic liquid mixture of N-mthyl-propyl piperidinium bis(fluoro sulfonyl)imide and 1-butyl-3-methylimidazolium bis(fluorosulfonyl)imide was prepared, and then this blend was mixed uniformly in the planetary centrifugal mixer (Trading No. SK350TV) and the obtained paste material was extruded on the surface of the negative electrode by heat press roll {FIG. 7 (a2-1)}.

### PRACTICAL EXAMPLE-11

Laminating the lithium metal foil on the cupper foil collector was used in instead of the negative electrode produced by Second Step—II and then by coating polyether polyol solution containing 3% of light polymerizable initiator (Irgacure369) to the surface of the lithium metal foil and by irradiating LED lump 30 mW/cm² at 365 nm for 2 minutes, coated film having 10 μm was obtained. As the result, the coated film had the improved reduction resistance and no occurring of dendrite {FIG. 7 (a2-2)}.

### PRACTICAL EXAMPLE-12

10 wt. % of GARNET, e.g., LIZO-Al (Trading No. 300 nm; inorganic solid state electrolyte; produced by Ampcera Co., Ltd.) was solved in acetonitrile solution. And a mixture of ion conductive polymer system (Trading No. CE2100 produced by Piotek Co., Ltd.) and Li salt (LiFSI) was produced. These materials were uniformly mixed and the casting slurry having low viscosity (not more than 20 cps) was produced.

In advance the positive electrode (Trading No. NCM85105 positive electrode produced by Piotrek Co., Ltd.) having the closed pack voids structure (at least 70% filled in voids) was produced by using active material containing high content of Ni {LiN_{8.5}Co_{1.0}Mn_{0.5} produced by Cosmo Co., Ltd.}, conductive agent (Super C65) and ion conductive polymer binder (CBC5630FP ex Piotrek). To this positive electrode, the casting slurry as shown above was impregnated at 40° C. (Second step—II). The casting slurry as shown above, containing the conductive polymer and the inorganic solid state electrolyte was multi-impregnated by biaxial roll (at 50° C.) while changing the concentration of the slurry (Third step—III).

Then by heat-treating the inorganic solid state electrolyte containing electrode and the conductive polymer system NCM electrode at 80° C. for 20 minutes, the inorganic solid state electrolyte containing in the electrode and the ion conductive polymer system was bond each other in hetero-couple. And the conductive network having 100 Ω of complex impedance resistance of the electrode was achieved and the charge transfer coefficience (charge transport number) was confirmed at more than 0.5. As the result the electrode controlling the surface resistance was produced.

This method is applicable for the positive electrode such as LCO, NCA (NiCoAl), L(N)MO, LFP, and for the negative electrode such as natural graphite, artificial graphite, LTO, silicone carbon and the like. Further this method is also applicable for the inorganic solid state electrolyte such as NASICON, GARNETT and so on. By providing the inorganic solid state electrolyte and ion conductive polymer system to the upper parts of the electrode having the closed pack voids structure and by coating the casting slurry by a comma coating method or a die coating method, these materials were integrally molded.

### PRACTICAL EXAMPLE-13

The mixture of the ion conductive binder (Trading No. CE2100 produced by Piotrek Co., Ltd.), LiNi₆Co₂Mn₂ active material and conductive agent (Super C65) was prepared. By adding low viscosity solution having not more than 20 cps of polyether allyl glycidyl ether liquid containing Li salt at more than 40° C. to the above mixture, the positive electrode having the closed pack voids structure was prepared. Then by impregnating THF solution of the ion conductive polymer system (Trading No. CE2100 ex. Piotrek) to the above positive electrode while defoaming completely, the desired positive electrode was produced. The impregnation was carried out by using biaxial roll at more than 50° C. in multi stages (Second step—II).

To this positive electrode, THF casting slurry containing (1) Li₃PS₄, 75% Li₂S.25% P₂S₅ sulfide inorganic solid state electrolyte and (2) ion conductive polymer system (Trading No. CPM Polymer ex. Piotrek) in ratio of (1):(2)=70:30 was impregnated by comma coating method. As the result, the conductive electrolyte layer having a thickness of 5 μm was formed (Third step—III).

The negative electrode was laminated to thus obtained positive electrode, and then by drying the laminate at 80° C. for 20 minutes at vacuum force at −0.1 mPa, the electrode containing the inorganic solid state electrolyte was produced (Fourth step—IV). As the result, a half cell having not more than 100 Ω of complex impedance resistance of the electrode was achieved by controlling the surface resistance between the electrode and the inorganic solid state electrolyte.

This method is applicable for sulfide-inorganic solid state electrolyte such as LiP₂S₅ and LISICON, and then not more than 80 Ω of a complex impedance is achieved.

Further, this method is applicable also for the positive electrode having the closed pack voids structure such as LiFePO, Ni high content NMC, Li(N)MO and for the negative electrode having the closed pack voids structure such as natural spherical graphite, LTO, Si—C as active materials. By changing the ratio of the inorganic solid state electrolyte and the conductive polymer matrix system to the ratio of 85:15, a cell having higher conductivity can be obtained.

### INDUSTRIAL APPLICABILITY OF THIS INVENTION

According to this invention, a rechargeable battery having negative electrode processed with the inorganic solid state electrolyte and positive electrode surface-processed in integral molding can be obtained in extremely competitive production cost, and without any use of separator a rechargeable battery in no occurring dendrite and restraining a grain boundary resistance between a positive electrode and a negative electrode to the fullest can be obtained.

And so this invention is greatly expected as the process for producing the solid state electrolyte rechargeable battery in practical production. field
1. mixing process of positive electrode slurry
2. coating process
3. drying process
4. a roll of positive electrode
5. sheet transfer of positive electrode
6. a roll of positive electrode set up in ICPm coater machine
7. ICPm feeder 1^{st} tank
8. supporting roller
9. 2nd step feeder tank
10. drying (buffer room and vacuum room, or non-vacuum box)
11. a roll of filled positive electrode sheet
12. mixing process of negative electrode slurry
13. coating process
14. drying process
15. A roll of negative electrode
21. a roll of positive electrode filled with ICPm
22. ICPm filled positive electrode sheet
23. ICPm-SE feeder tank
24. supporting roller
25. heating process
26. press roller
27, integral molding roll of positive electrode sheet
31. a roll of ICPm filled negative electrode sheet
32. sheet transfer of ICPm filled negative electrode
33. a roll of integral molding positive electrode
34. sheet transfer of integral molding positive electrode
35. supporting roller
36. press roller or heat-press roller
37. laminated sheet of the positive electrode with the negative electrode
38. wound cell
39. stack cell
41. roll sheet of lithium metal
42. roll sheet of copper electrics collector
43. roll sheet of lithium metal foil
44. supporting roller
45. supporting roller
46. supporting roller
47. press roller
48. press roller
49. coating process of non-polar conductive polyether type polymer
50. die coating head
51. supporting roller
52. thermosetting and drying chamber
53. supporting roller
54. press roller
55. supporting roller
56. pinhole detector
57. supporting roller
58. press roller
59. a roll sheet of buffer layer coated lithium metal foil-copper electrics collector
60. a roll of Lithium metal foil sheet laminated on copper collector
61. press roller
62. ICPm gel paste extruding heads
63. heat press roller
71. UV curing box (process)

1. A manufacturing process for a rechargeable battery making a coating layer with the casting slurry comprising a conductive polymer and an inorganic solid state electrolyte or placing a membrane comprising a conductive polymer and an inorganic solid state electrolyte between positive and negative electrodes, which comprises the First step—I of preparing a positive electrode comprising an active material, a conductive agent and an ion conductive binder, and herein having at least 70% of the closed pack structure and the Second step—II of impregnating in filling or surface coating in a thin layer with a conductive polymer solution toward the positive electrode obtained by the First step—I, the Third step—III of preparing the positive electrode made in an integral formation by coating a casting slurry containing the conductive polymer solution and the inorganic solid state electrolyte on those surfaces or by pressing the membrane comprising the conductive polymer and the inorganic solid state electrolyte in two layer formation on the positive electrode, obtained by the Second step—II, the Fourth step—IV processing by heating the positive electrode obtained by the Third step—III at 60 to 100° C. for 5 to 60 minutes, and the Fifth step—V processing by heat-pressing in overlaying the positive electrode obtained by the Fourth step—IV with the negative electrode.

2. A manufacturing process for a rechargeable battery making a coating layer with the casting slurry comprising a conductive polymer and an inorganic solid state electrolyte or placing a membrane comprising a conductive polymer and an inorganic solid state electrolyte between positive and negative electrodes, which comprises the First step—I of preparing a negative electrode comprising an active material, a conductive agent and an ion conductive binder and herein having at least 70% of the closed pack structure having and the Second step—II of impregnating in filling or surface coating in a thin layer with a conductive polymer solution toward the negative electrode obtained by the First step—I, the Third step—III of preparing the negative electrode made in an integral formation by coating a casting slurry containing the conductive polymer solution and the inorganic solid state electrolyte on those surfaces or by pressing the membrane comprising the conductive polymer and the inorganic solid state electrolyte in two layers formation on the negative electrode, obtained by the Second step—II, the Fourth step—IV processing by heating the negative electrode obtained by the Third step—III, at 60° C. to 100° C. for 5 to 60 minutes, and the Fifth step—V processing by heat-pressing in overlaying the negative electrode obtained by the Fourth step—IV with the positive electrode

3. A manufacturing process for a rechargeable battery as claimed in claim 1, wherein the negative lithium metal electrode forming a polyether type polymer layer as a dendrite generation buffer on the one side surface or the both side surface of a lithium metal foil is used as the negative electrode part.

4. A manufacturing process for a rechargeable battery as claimed in claim 1, wherein an ionic liquid and/or an charge transfer ion source are included into the conductive polymer solution in the Second step—II and/or the casting slurry containing the conductive polymer solution and the inorganic solid state electrolyte in the Third step—III.

5. A manufacturing process for a rechargeable battery as claimed in claim 1, wherein processing in drying is carried out at not more than 120° C. for 5 minutes to not longer than one hour after impregnating in filling or after coating the conductive polymer solution to the positive and negative electrodes in the Second step—II.

6. A manufacturing process for a rechargeable battery as claimed in claim 1, wherein at least one kind of the conductive binder and the conductive polymer is made by polymeric conductive composition obtained by graft polymerizing or living radical polymerization of a molten salt monomer having a polymerizable functional group and having an onium cation and an anion containing a halogen with a fluoro polymer,

7. A manufacturing process for a rechargeable battery as claimed in claim 1, wherein the ionic liquid is a molten salt having an onium cation and an anion containing a halogen, and the charge transfer ion source is lithium charge transfer ion source, and the conductive polymer having a lamellar structure is formed in the heating process in the Fourth step—IV.

8. A manufacturing process for a rechargeable battery as claimed in claim 1, wherein the inorganic solid state electrolyte is at least one kind selected material from the group consisting of Garnet, NASICON type crystal structure in oxide materials, a perovskite-type material and sulfide materials.

9. A manufacturing process for a rechargeable battery as claimed in claim 1, wherein a polyether type polymer is contained in at least one layer selected from the group consisting of the coating layer comprising a conductive polymer and an inorganic solid state electrolyte, the membrane comprising a conductive polymer and an inorganic solid state electrolyte, the positive electrode layer and the negative electrode layer.
